(19) United States
(12) Patent Application Publication
(10) Pub. No.: US 2026/0234502 A1
(43) Pub. Date: Aug. 13, 2026

(54) PROCESS FOR PRODUCING A PALM OIL FRACTION USING SEEDS

(71) Applicant: Cargill, incorporated, Wayzata, MN (US)

(72) Inventors: Walter Jacobus Godefridus BIERENS, Dordrecht (NL); Rob Jacobus Godefridus DEKKER, Delfgauw (NL); Armin Willem-Friedrich Hermann TARNOW, Rotterdam (NL)

(73) Assignee: Cargill, incorporated, Wayzata, MN (US)

(21) Appl. No.: 19/155,364

(22) PCT Filed: Feb. 23, 2024
(86) PCT No.: PCT/US2024/017001

§ 371 Date: Aug. 11, 2025

(30) Foreign Application Priority Data
Feb. 23, 2023 (EP) 23158249.5

(51) Int. Cl. C11B 1/10

(52) U.S. Cl. CPC C11B 1/10

(57) ABSTRACT

The present disclosure relates to a process for producing a hard palm mid fraction (hard PMF) comprising the following steps of: (a) cooling a pre-mixture of a palm olein starting material and a solvent, and obtaining a mixture that comprises the solvent and solid from the palm olein starting material; and (b) separating the mixture obtained in step (a) into a solid fraction and a liquid fraction, in which the solid fraction is the hard PMF, wherein the pre-mixture in step a) is cooled at a speed in a range of from 0.1 to 0.8° C. per minute; and wherein a seeding agent comprising solid fat is added in step a) at a temperature is in a range of from 7° C. to 14° C.; wherein the mixture of solvent and solids from the palm olein starting material is cooled in step a) until a temperature of from 4° C. to 8° C., is reached.

### CROSS-REFERENCE TO RELATED APPLICATIONS

This application claims the benefit of European Patent Application No. 23158249.5, filed 23 Feb. 2023, which is incorporated by reference herein in its entirety.

### FIELD OF THE INVENTION

The present invention relates to a novel fractionation process for producing a hard palm mid fraction from a palm olein starting material.

### BACKGROUND

Cocoa butter equivalents (CBEs), which have been commonly used in replacement of cocoa butter in chocolate making, are generally produced from mixture of exotic fats and hard PMF (PMF=palm mid fraction). However, the production of hard PMF usually involves several fractionation steps.

Hard PMF is generally produced via fractionation of palm oil. Fractionation is primarily a separation process in which fat is crystallized and subsequently separated from the liquid phase. There are three common types of fractionations, namely dry fractionation, solvent fractionation, and detergent fractionation. Solvent fractionation involves the addition of solvent to oil to promote crystallization, followed by separation via filtration into a liquid fraction, also called an olein fraction, and a solid fraction, also called a stearin fraction. In diluted or less viscous solutions when solvent is added, higher separation efficiency can be achieved as compared to when solvents are not used. Crystallization of solvent fractionation is commonly carried out via scraped surface heat exchanger process or in a batch crystallizer cooled by vacuum-evaporation of solvent.

Generally, the fractionation of palm oil into hard PMF is performed by means of multiple subsequent fractionation steps, whereby a solid or liquid fraction obtained from one fractionation step is used as staring material for a subsequent fractionation step. Processes in the art disclose that hard PMF can be produced from palm olein (IV 56), i.e. an olein fraction from palm oil, using three steps of dry fractionation, with or without ultrasound assisted, or two steps of solvent fractionation, or a combination of two dry fractionation steps and one solvent fractionation step.

With multiple fractionation process steps (as is the case for the traditional fractionation processes to obtain hard PMF), multiple co-fractions are generated that require a useful outlet. Multiple number of storage tanks are required for storage of intermediate products and co-fractions, which requires higher investment cost. In every fractionation process step oil loss happens which may result in lesser yields. In addition, the described processes in the art, involving multiple fractionations, require a longer process time.

Hence, there remains improvement for fractionation process of hard PMF with less fractionation process steps, less side fractions, less consumption of solvent, less consumption of energy to produce desirable product quality and/or relatively high yield.

### SUMMARY

The present disclosure provides a process for producing a hard palm mid fraction (hard PMF) that comprises the steps of: (a) cooling a liquid pre-mixture of a palm olein starting material and a solvent, and obtaining a mixture that comprises the solvent and solids from the palm olein starting material; and (b) separating the mixture obtained in step (a) into a solid fraction and a liquid fraction, in which the solid fraction being the hard PMF and wherein the liquid pre-mixture of a palm olein starting material and a solvent in step a) is cooled at a speed in a range of from 0.1 to 0.8° C. per minute; and wherein a seeding agent comprising solid fat is added in step a) at a temperature is in a range of from 7° C. to 14° C.; and wherein the mixture of solvent and solids from the palm olein starting material is cooled in step a) until a temperature of from 4° C. to 8° C., is reached. A seeding agent comprising solid fat is added in step (a) at a temperature that is in the metastable solubility zone of the pre-mixture of palm olein starting material and solvent.

### DETAILED DESCRIPTION

Reference will now be made in detail to certain aspects of the disclosed subject matter, examples of which are illustrated in part in the accompanying drawings. While the disclosed subject matter will be described in conjunction with the enumerated claims, it will be understood that the exemplified subject matter is not intended to limit the claims to the disclosed subject matter.

Unless defined otherwise, all technical and scientific terms used herein have the same meaning as commonly understood by one skilled in the art to which this invention belongs. As used herein, each of the following terms has the meaning associated with it as defined below.

Unless expressly stated, ppm (parts per million), percentage, and ratios are on a by weight basis. Percentage on a by weight basis is also referred to as wt. % below.

The term “for example,” “for instance,” “such as,” or “including” as used herein is meant to introduce examples that further clarify more general subject matter. Unless otherwise specified, these examples are provided only as an aid for understanding the applications illustrated in the present disclosure and are not meant to be limiting in any fashion.

As used herein, “room temperature” or “RT” refers to a temperature between 20° C. to 25° C.

### Method for Producing a Palm Oil Product

The present disclosure relates to a process of producing a hard palm mid fraction (hard PMF), comprising the steps of (a) cooling a liquid pre-mixture of a palm olein starting material and a solvent, and adding a seeding agent comprising solid fat, to obtain a mixture that comprises the solvent and solids from the palm olein starting material; and (b) separating the solids from the liquids in the pre-mixture obtained in step (a). The seeding agent is added in step a) at a temperature that is in the metastable solubility zone of the pre-mixture of palm olein starting material and solvent, and wherein the liquid pre-mixture of a palm olein starting material and a solvent in step a) is cooled at a speed in a range of from 0.1 to 0.8° C. per minute; and wherein a seeding agent comprising solid fat is added in step a) at a temperature is in a range of from 7° C. to 14° C.; and wherein the mixture of solvent and solids from the palm olein starting material is cooled in step a) until a temperature of from 4° C. to 8° C., is. The solid fraction obtained in step (b) is the hard PMF and the liquid fraction obtained in step (b) is a mixture of solvent and liquid oil.

### The Palm Olein Starting Material

“Palm olein starting material”, as used herein, refers to palm olein having an iodine value (IV) of from 55 to 58, preferably of 56 (hereafter called “palm olein IV56”). Furthermore, the palm olein may have a solid fat content (SFC), measured according to standard method of IUPAC 2.150a, as shown in Table 1, and a triglyceride composition comprising the triglycerides as shown in Table 2.

TABLE 1

| Solid Fat Content | |
|---|---|
| according to IUPAC method 2.150a | Weight % |
| N10 | 25-35; preferably 31 |
| N20 | 2-8; preferably 4 |
| N25 | Maximum 2; |
| | preferably 0 |

TABLE 2

| Triglyceride content | |
|---|---|
| according to AOCS Ce5-86 method | Weight % |
| Tripalmitoylglycerol (PPP) | Maximum 2; preferably 1 |
| 1,3-dipalmitoyl-2-oleoyl-glycerol (POP) | 25-40; preferably 31 |
| 1,2-dioleoyl-3-palmitoyl-glycerol (POO) | 20-35; preferably 26 |

In a preferred aspect, the palm olein starting material used for the process of the present invention is a refined, bleached and/or deodorized oil. Most preferably, the palm olein starting material is an RBD oil, i.e. a refined, bleached and deodorized oil.

### The Premixture of Solvent and Palm Olein Starting Material

In step a) of the process according to the invention, a pre-mixture of solvent and palm olein starting material is subjected to a cooling process. The pre-mixture is in a completely melted state. In other words, the pre-mixture of solvent and palm olein starting material is thus prior to step a) at a temperature at which no visible solid fat particles are present in the pre-mixture.

The pre-mixture is obtained by mixing palm olein starting material and solvent in a weight ratio of palm olein starting material/solvent in a range of from 1/6 to 1/0.5, from 1/3 to 1/0.75, such as 1/1 or 1/2 to obtain a pre-mixture (for example a palm olein starting material/solvent of ⅙ being a mixture of 1 part (expressed in weight) palm olein starting material and 6 parts (expressed in weight) solvent). Examples of solvent include, but are not limited to, acetone, hexane, heptane, isopropyl alcohol, methanol, or a combination of two or more thereof. Preferably, the solvent is acetone.

### Seeding Agent

The seeding agent is comprising solid fat. The solid fat of the seeding agent can be any non-lauric fat (i.e., a fat having a fatty acid composition that comprises at most 5% C12, at most 2% C12, or at most 1% C12). Examples of non-lauric fat include, but are not limited to, palm-based oil, cocoa butter, shea butter, shea stearin, or any combination of two or more thereof.

The solid fat of the seeding agent may have a content of SUS triglycerides of at least 25 wt. %, at least 27 wt. %, or at least 30 wt. % based on the total weight of the triglyceride composition of the seeding agent. An SUS triglyceride is characterized by the position of the saturated(S) and/or unsaturated (U) fatty acids bound onto the glycerol backbone of the triglycerides. Typically, the abbreviation S is used to denote a saturated fatty acid residue having 8 to 24 carbon atoms. The abbreviation U denotes an unsaturated fatty acid residue having 18 carbon atoms. Thus, a SUS triglyceride represents a triglyceride having two saturated fatty acids on the 1^{st} and 3^{rd} glycerol positions and one unsaturated fatty acid on the 2^{nd} glycerol position, with the saturated fatty acids being in a range of C8 to C24 and the unsaturated fatty acids having 18 carbon atoms. Examples of SUS triglycerides include, but are not limited to 1,3-dipalmitoyl-2-oleoyl-glycerol (POP), 1-palmitoyl-2-oleoyl-3-stearoylglycerol (POSt), 1,3-distearoyl-2-oleoyl-glycerol (StOSt), 1,3-dipalmitoyl-2-linoyl-glycerol (PLP), 1-palmitoyl-2-linoyl-3-stearoylglycerol (PLSt), 1,3-distearoyl-2-linoyl-glycerol (StLSt).

Preferably, the solid fat of the seeding agent has a content of SOS triglycerides, expressed on the total weight of the triglyceride composition of at least 25 wt. %, at least 27 wt. %, or at least 30 wt. %, where in the abbreviation S is used to denote a saturated fatty acid residue having 8 to 24 carbon atoms and the abbreviation O denotes an unsaturated fatty acid residue being oleic acid. Examples of SOS triglycerides include 1,3-dipalmitoyl-2-oleoyl-glycerol (POP), 1-palmitoyl-2-oleoyl-3-stearoylglycerol (POSt) and 1,3-distearoyl-2-oleoyl-glycerol (StOSt),

In a preferred aspect, the solid fat of the seeding agent is selected from the group consisting of cocoa butter, shea butter, shea stearin, illipe butter, palm oil, palm fractions such as palm olein IV 55-58, soft palm mid fraction (soft PMF) IV 42-48, soft stearin IV 40-42, hard PMF IV 32-36, or a combination of two or more thereof. More preferably, the solid fat of the seeding agent is selected from soft PMF, soft stearin, hard PMF, or a combination of two or more thereof.

The solid fat of the seeding agent can be in the form of particles having an average diameter of at most 2 mm, at most 1 mm, or at most 0.5 mm.

The seeding agent can be in powder form or in the form of a slurry comprising solid fat particles and liquid oil and/or a solvent. Preferably, the seeding agent is in the form of a slurry. This has the advantage that the seeding agent particles are already homogeneously mixed in the liquid oil and/or the solvent and it can be easily added to the pre-mixture of solvent and palm olein starting material.

The seeding agent may be prepared by separately cooling palm olein and forming solid fat particles in non-solidified liquid oil, or by separately cooling a mixture of palm olein and solvent and forming solid fat particles in solvent or a mixture of non-solidified liquid oil and solvent. It involves the preparation of the seeding agent in the form of a slurry (seeding slurry). This can be done separately, but a small amount of the previous production batch can be used.

In a preferred aspect, the seeding agent may be prepared by cooling a liquid mixture of a soft PMF (IV 42-48) with acetone in a weight ratio of soft PMF/acetone of in a range of from 1/6 to 1/0.5, from 1/3 to 1/0.75, such as 1/4 or 1/2. Preferably, the mixture soft PMF/solvent may be cooled to a temperature of about 10° C. A seeding agent is obtained comprising particles of solid fat from the soft PMF, solvent and liquid oil.

The amount of seeding agent added to the pre-mixture of palm olein starting material and solvent can be from 0.1 to 10 wt. %, preferably from 0.2 to 3 wt. %, or more preferably from 0.5 to 2 wt. %, based on the total weight of palm olein starting material in the pre-mixture.

The amount of seeding agent added to the pre-mixture of palm olein starting material and solvent can be from 0.01 to 1.00 wt. %, preferably from 0.02 to 0.30 wt. %, or more preferably from 0.05 to 0.20 wt. % expressed as the amount of solid fat in the seeding agent on the total weight of the palm olein starting material.

The amount of seeding agent added to the pre-mixture of palm olein starting material and solvent can be from 0.1 to 7 wt. %, preferably from 0.2 to 4 wt. %, or more preferably from 0.3 to 2 wt. % expressed as an amount of SUS in the seeding agent on the total weight of the palm olein starting material.

### Step a) Cooling Liquid Mixture of a Palm Olein Starting Material and Solvent

In step a) of the process according to the invention, the liquid pre-mixture of a palm olein starting material and a solvent is cooled. The seeding agent is added to the pre-mixture. A mixture comprising the solvent and solids from the palm olein starting material is obtained.

Preferably, the liquid pre-mixture of a palm olein starting material and a solvent is cooled at a speed in a range of from 0.1 to 0.8° C. per minute, from 0.2 to 0.7° C. per minute, or from 0.3 to 0.6° C. per minute, preferably from more than 0.3 to 0.7° C. per minute, more preferably from 0.4 to 0.5° C. per minute, such as 0.4° C. per minute.

The temperature at which the seeding agent is added to the pre-mixture of palm olein starting material and solvent is a temperature that is in the metastable solubility zone of the pre-mixture, i.e a temperature that is between the clear point and the cloud point of the pre-mixture of palm olein starting material and solvent. The metastable solubility zone of a solution is commonly defined as the temperature zone between the solubility curve (clear points) and the metastable limit curve (cloud points) and is the zone wherein crystallization processes occur in well-controlled way. A cloud point temperature is commonly defined as the temperature below which a transparent solution undergoes a liquid-solid phase transition to form a suspension that settles a precipitate. In other words, the cloud point is the temperature at which a solution becomes hazy upon cooling. A clear point temperature is defined as the temperature corresponding to the 100% transmissivity of a solution on heating, indicating the complete dissolution of solute.

In a preferred aspect, the temperature at which the seeding agent is added to the pre-mixture of palm olein and acetone is in a range of from 7° C. to 14° C., preferably from 8° C. to 13° C., most preferably from above 10° C. to 14° C., such as 13° C.

After the addition of seeding agent, the liquid pre-mixture of solvent and palm olein starting material is further cooled down and solid fat particles are formed from the palm oil starting material. A mixture comprising the solvent and solids originating from the palm olein starting material are obtained. Preferably, after or simultaneously with the addition of seeding agent, the liquid pre-mixture of solvent and palm olein starting material is further cooled down, until a mixture is obtained comprising the solvent and solids originating from the palm olein starting material in an amount of from 20 to 30%, preferably from 22 to 28% solids, or more preferably from 24 to 27%, such as 26%, expressed on the total weight of palm olein starting material.

In another preferred aspect, after or simultaneously with the addition of seeding agent, the obtained mixture of solvent and solids from the palm olein starting material is further cooled until a temperature of from 0° C. to 8° C., preferably from 4° C. to 8° C., more preferably from 4° C. to 7° C., most preferably from 5° C. to 6° C., is reached.

Preferably, the obtained mixture of solvent and solids from the palm olein starting material is cooled at a speed in a range of from 0.01 to 0.1° C. per minute, preferably from 0.02 to 0.07° C. per minute, more preferably from 0.03 to 0.06° C. per minute.

Step b) Separating the Mixture Obtained in Step a) into a Solid Fraction and a Liquid Fraction and Step c) Collecting the Solid Fraction.

In step (b). the mixture obtained in step (a) is separated into a solid fraction and a liquid fraction.

Step b) is conducted after step a) and is involving an intermediate residence time of less than 30 minutes, preferably less than 10 minutes. Preferably the residence time is less than 5 minutes.

Without being bound by any particular theory, by keeping the residence time short, soft triglycrides would not have the chance to crystallize. The short residence time allows collecting and obtaining the hard PMF with the characteristics as identified and mentioned below.

Separation can be done in an apparatus such as a vacuum belt filter. The solid fraction that is obtained as a filter cake may be washed with solvent (e.g. acetone) to remove entrained liquid oil between the solids. The solid fraction is further purified by removal of the solvent. The solid fraction obtained by the process is the hard PMF.

Preferably, solvent can be recovered from the solid fraction and/or the liquid fraction; more preferably, the recovered solvent can be recycled into step (a).

Quality of the hard PMF may be further improved by a deodorization step. Preferably the hard PMF is subjected to a deodorization step at a temperature in a range of from 180 to 210° C., from 185 to 205° C., or from 190 to 200° C.

The solid fraction obtained in step (b) and collected in step c) is a hard palm mid fraction (PMF) that has an IV of from 30 to 37, preferably from 31 to 36, or more preferably from 32 to 35.

Preferably, the solid fraction obtained in step (b) and collected in step c) can have:
a content of tri-palmitoyl-glycerol (PPP) of less than 5 wt. %, preferably less than 4 wt. %, more preferably less than 3.5 wt. %, or even more preferably from 1.5 to 3.5 wt. %;
a content of 1,3-dipalmitoyl-2-oleoyl-glycerol (POP) of greater than 65 wt. %, preferably greater than 70 wt. %, or more preferably greater than 72 wt. %; and
a content of 1,2-dioleoyl-3-palmitoyl-glycerol (POO) of less than 5 wt. %, preferably less than 4 wt. %, or more preferably less than 2.5 wt. %.

Preferably, the solid fraction obtained in step (b) and collected in step c) has a solid fat content (SFC), measured according to IUPAC method 2.150b:
at 20° C., of more than 82%, preferably in a range of from 82.0 to 94.0%, more preferably from 84.0 to 93.0%, most preferably from 86.0 to 92.0%, and
at 35° C., of less than 6%, preferably in a range of from 0.0 to 5.0%, more preferably from 0.0 to 4.0%, most preferably from 0.0 to 3.5%.

Preferably, the liquid fraction that is obtained from step b) and which can also be collected is comprising solvent and liquid oil. The liquid oil is further purified by removal of the solvent typically by means of evaporation. The liquid oil that is obtained by the process of the current invention is a palm olein having an IV in a range of from 60 to 70, preferably from 61 to 68, or more preferably from 62 to 65 (e.g., an IV of about 64).

In aspect of the invention, the process is comprising no further fractionation steps.

### Effects of the Process

The process of the present invention for obtaining a hard palm mid fraction with IV in a range of from 31 to 38, preferably from 32 to 37, more preferably from 33 to 36, results in a reduction of the amount of process steps required, and/or a reduction of the processing time.

### Single Process Step

Without being bound by any theory, the process according to the present invention may allow for a promotion of formation of desired symmetrical crystals (POP) while the formation of undesired asymmetrical triglycerides, such as POO (example of soft triglycerdies), is reduced, and that may contribute to the desirable quality of the resulting hard PMF. As a result, by using the process of the present disclosure, a desired hard PMF can be achieved with a single process step as compared to conventional processes that involve several fractionation steps. By conducting the cooling until a temperature of from 4° C. to 8° C. and/or involving an intermediate residence time of less than 30 minutes, preferably less than 10 minutes and even shorter, less soft triglycrides would have the chance to crystallize and end up in the solid fraction, thus allowing to obtain the hard PMF as described before.

With the process of the present invention, only one co-fraction is generated as compared to the multiple co-fractions generated from the multiple fractionation steps in conventional processes. The co-fraction that is obtained by the process according to the present invention is a palm olein having an Iodine Value (IV) in a range of from 62 to 68, such as 64.

Further, the entire process can happen in just one reactor without one or multiple transfer(s) of the process materials as in conventional processes; thus, the risk of material loss during transfer can be minimized or even avoided.

### Shorter Production Time

Process time of the present inventive process is about 2.5 hours, including a short an intermediate residence time of less than 30 minutes, preferably less than 10 minutes and even shorter; while dry fractionation in the conventional processes use 10 hours or more. Thus, process time may be saved for at least 75% with the present inventive process.

### Higher Yield

The yield of hard PMF using palm olein IV56 as the starting material in a conventional fractionation process is about 10 to 20%, where palm olein IV56 is first fractionated into PMF having an IV of 45 (PMF IV45), subsequently topped and further fractionated into hard PMF.

The process of the present invention has a significantly higher yield of hard PMF in a range of from 20 to 30%, from 22 to 28%, or from 23 to 27%, for example 26%.

Due to the higher yield of hard PMF obtained by the process according to the invention, the amount of co-fraction, being only one single co-fraction, is lower.

Therefore, the present inventive process requires less investment in equipment, and less processing costs, as compared to conventional fractionation processes.

### Products Obtained by and Collected in the Process

The present disclosure also relates to the products that are directly obtained by the process of the present invention. In particular, the present disclosure relates to a hard palm mid fraction (hard PMF), obtainable by the present process.

The hard PMF obtained has an IV in a range of from 30 to 37, preferably from 31 to 36, or more preferably from 32 to 35. The hard PMF has the following triglyceride contents:
a content of tripalmitoylglycerol (PPP) of less than 5 wt. %, preferably less than 4 wt. %, more preferably less than 3.5 wt. %, or even more preferably from 1.5 to 3.5 wt. %;
a content of 1,3-dipalmitoyl-2-oleoyl-glycerol (POP) of greater than 65 wt. %, preferably greater than 70 wt. %, or more preferably greater than 72 wt. %; and
a content of 1,2-dioleoyl-3-palmitoyl-glycerol (POO) of less than 5 wt. %, preferably less than 4 wt. %, or more preferably less than 2.5 wt. %.

The hard PMF obtained has a solid fat content (SFC), measured according to IUPAC method 2.150b:
at 20° C., of more than 82%, preferably in a range of from 82.0 to 94.0%, more preferably from 84.0 to 93.0%, most preferably from 86.0 to 92.0%, and
at 35° C., of less than 6%, preferably in a range of from 0.0 to 5.0%, more preferably from 0.0 to 4.0%, most preferably from 0.0 to 3.5%.

### End Application of the Products Obtained by the Process

The hard PMF obtained by the process of the present invention can be used in various applications, including but not limited to, producing cocoa butter equivalents (CBE) or being used in any other food application.

With its solid fat content (SFC) profile, the hard PMF obtained by the present inventive process gives sharp melting and clean mouthfeel that are especially desirable in confectionary applications. The hard PMF is a POP-rich fat that makes it possible to blend with exotic fats such as shea butter, shea stearin, illipe butter, sal fat, mango kernel fat, kokum gurgi fat or combinations of two or more thereof. The resulting blend, i.e; a cocoa butter equivalent, can achieve a 100% compatibility with cocoa butter without changing the characteristics of the final products.

### EXAMPLES

The invention is further described in detail by reference to the following experimental examples. These examples are provided for purposes of illustration only and are not intended to be limiting unless otherwise specified. Thus, the invention should in no way be construed as being limited to the following examples, but rather should be construed to encompass any and all variations which become evident as a result of the teaching provided herein.

### Example 1

### Materials and Method

### 1. The Palm Olein Starting Material

Palm olein (IV56) having an IV, solid fat content and triglyceride composition as shown in table 3 was used as palm olein starting material.

TABLE 3

| Attributes | Palm olein IV56 |
|---|---|
| IV - according to Wijs method | 56.0 |
| (AOCS method Cd1-25) | |

Solid Fat Content - according to
standard method of IUPAC 2.150a

| | |
|---|---|
| N10 | 34.7% |
| N20 | 4.9% |
| N25 | 0.8% |

Triglyceride composition - according to AOCS Ce5-86 method

| | |
|---|---|
| Tri-palmitoyl-glycerol (PPP) | 0.74 wt. % |
| 1,3-dipalmitoyl-2-oleoyl-glycerol (POP) | 35.0 wt. % |
| 1,2-dioleoyl-3-palmitoyl-glycerol (POO) | 23.7 wt. % |

### 2. The Seeding Agent

A seeding agent was prepared by cooling a solution of soft palm mid fraction (soft PMF) in acetone at a weight ratio of soft PMF/acetone, 1 to 3 to a temperature of 10° C. A slurry is obtained, i.e. the seeding agent, comprising solid fat particles, liquid oil and solvent. The slurry had a content of fat particles of 10 wt. %, expressed on total weight of the soft PMF starting material.

3. Step (a)—Cooling Liquid Mixture of a Palm Olein Starting Material and Solvent

The palm olein IV56 starting material was blended with acetone as solvent in a weight ratio of, palm olein to acetone, 1 to 3. The resulting pre-mixture was heated until all fats were dissolved.

The heated pre-mixture of palm olein and acetone was cooled in a reaction vessel with a speed of 0.4° C. per minute to a temperature of around 13° C. At this temperature, the seeding slurry was added at a dose level of 1 wt. % based on the total weight of the pre-mixture of solvent and palm olein starting material. The pre-mixture of palm olein starting material and solvent, together with the added seeding agent is further cooled down from 13° C. to 6.1° C. in 1 h and 50 minutes (110 minutes). A mixture comprising the solvent and solids from the palm olein starting material was obtained. The mixture at the end of step a) had a temperature of 6.1° C. The mixture at the end of step a) had a content of 22% of solids expressed on total weight of the palm olein starting material palm olein. The amount of solids was determined by separating liquid and solid fraction by means of filtration and subsequently weighing both fractions.

4. Step b) Separating the Mixture Obtained in Step a) into a Solid Fraction and a Liquid Fraction

When reaching the temperature of 6.1° C. the mixture was filtered. The mixture of solid fat, solvent and liquid oil obtained from step a) was filtered on a cooled filter. A solid fraction being retained on the filter, i.e. the hard PMF and a liquid fraction, i.e. a mixture of liquid oil and solvent. The solid fraction on the filter was washed with cold acetone (at 5° C.). Acetone was then removed from the solid fraction and from the liquid fraction through evaporation.

### 5. Hard PMF Obtained

The yield, IV, and solid fat contents (SFC) and triglyceride composition of the hard PMF obtained by the process of the present invention are shown in Table 1.

TABLE 4

| | Sample |
|---|---|
| | according to |
| Attributes | the invention |
| Hard PMF Yield (%)* | 22% |
| IV - according to Wijs method | 32.3 |
| (AOCS method Cd1-25) | |

Solid Fat Content - according to IUPAC method 2.150b

| | |
|---|---|
| N20 | 90.4% |
| N25 | 81.4% |
| N30 | 50.0% |
| N35 | 3.3% |

Triglyceride composition - according to AOCS Ce5-86

| method | | |
|---|---|---|
| 1,3-dipalmitoyl-2-oleoyl-glycerol (POP) | 76.8 | wt. % |
| 1,2-dioleoyl-3-palmitoyl-glycerol (POO) | 1.8 | wt. % |
| Tri-palmitoyl-glycerol (PPP) | 2.2 | wt. % |

*Yield (in percentage) is the mass fraction of crystallized fat (Hard PMF fraction) versus the mass of the starting material

1. A process for producing a hard palm mid fraction (hard PMF), which comprises:
a) cooling a liquid pre-mixture of a palm olein starting material and a solvent, and obtaining a mixture comprising the solvent and solids from the palm olein starting material; and
b) separating the mixture obtained in step a) into a solid fraction and a liquid fraction, the solid fraction being the hard PMF;
wherein a seeding agent comprising solid fat is added in step a) at a temperature that is in the metastable solubility zone of the pre-mixture of palm olein starting material and solvent; and
wherein the liquid pre-mixture of a palm olein starting material and a solvent in step a) is cooled at a speed in a range of from 0.1 to 0.8° C. per minute; and
wherein a seeding agent comprising solid fat is added in step a) at a temperature is in a range of from 7° C. to 14° C.; and
wherein the mixture of solvent and solids from the palm olein starting material is cooled in step a) until a temperature of from 4° C. to 8° C., is reached.

2. The process according to claim 1, wherein step b) is conducted after step a) and involving an intermediate residence time of less than 30 minutes, preferably less than 10 minutes.

3. The process according to claim 1, further comprising step c) of collecting the solid fraction; and the solid fraction is a hard PMF having an IV in a range of from 30 to 37, preferably from 31 to 36, or more preferably from 32 to 35.

4. The process according to claim 1, wherein the liquid pre-mixture of a palm olein starting material and a solvent of step a) is cooled at a speed in a range of from 0.2 to 0.7° C. per minute, preferably from more than 0.3 to 0.7° C. per minute, more preferably from 0.4 to 0.5° C. per minute.

5. The process according to claim 1, wherein the process is comprising no further fractionation steps.

6. The process according to claim 1, wherein the palm olein starting material has an iodine value (IV) in a range of from 55 to 58, from 54 to 58, or from 55 to 57.

7. The process according to claim 1, wherein the seeding agent has a triglyceride composition comprising at least 25 wt. %, at least 27 wt. %, or at least 30 wt. % of SUS triglycerides based on the total weight of the triglyceride composition; preferably wherein the seeding agent is selected from the group consisting of cocoa butter, shea butter, shea stearin, illipe butter, palm oil, palm fractions such as palm olein IV 55-58, soft palm mid fraction (soft PMF) IV 42-48, soft stearin IV 40-42, hard PMF IV 32-36, or any combination of two or more thereof, preferably the seeding agent is selected from the group consisting of soft PMF, soft stearin, hard PMF, or any combination of two or more thereof.

8. The process according to claim 1, wherein the seeding agent is added to the pre-mixture of palm olein starting material and solvent in an amount of from 0.1 to 10 wt. %, from 0.2 to 3 wt. %, or from 0.5 to 2 wt. % based on the total weight of palm olein starting material in the pre-mixture.

9. The process according to claim 1, wherein the seeding agent is added to the pre-mixture of palm olein starting material and solvent in an amount of from 0.1 to 7 wt. %, preferably from 0.2 to 4 wt. %, or more preferably from 0.3 to 2 wt. % expressed as an amount of symmetrical SUS in the seeding agent on the total weight of the palm olein starting material.

10. The process according to claim 1, where the seeding agent is in the form of a slurry a slurry comprising solid fat particles and liquid oil and/or a solvent.

11. The process according to claim 1, where the seeding agent is obtained by cooling a mixture of palm olein and solvent and forming solid fat particles in a solvent or a mixture of non-solidified liquid oil and solvent; or the seeding agent is obtained by cooling palm olein and solvent and forming solid fat particles in a non-solidified liquid oil.

12. The process according to claim 1, wherein the palm olein starting material and the solvent are in a weight ratio of at least 1 to 0.5 and at most 1 to 4, preferably at a weight ratio of 1 to 3, in the pre-mixture.

13. The process according to claim 1, wherein the seeding agent is in the form of solid particles having an average diameter of at most 2 mm, at most 1 mm, or at most 0.5 mm.

14. The process according to claim 1, wherein the solid fraction collected in step c) is a hard PMF having a content of tri-palmitoyl-glycerol (PPP) of from 1.5 to 3.5 wt. %, a content of 1,3-dipalmitoyl-2-oleoyl-glycerol (POP) of greater than 72 wt. %, and/or a content of 1,2-dioleoyl-3-palmitoyl-glycerol (POO) of less than 2.5 wt. % based on the total weight of triglycerides.

15. The process according to claim 1, wherein the solid fraction collected in step c) has a solid fat content (SFC) at 20° C. in a range of from 82.0 to 94.0%, from 84.0 to 93.0%, or from 86.0 to 92.0%; and a solid fat content (SFC) at 35° C. of at most 5.0%, at most 4.0%, or at most 3.5%; wherein SFC is measured according to IUPAC 2.150 (b) method.
